(19) United States
(12) Patent Application Publication
(10) Pub. No.: US 2008/0169399 A1
(43) Pub. Date: Jul. 17, 2008

(54) ATTACHABLE HOLDER FOR ITEMS

(76) Inventor: Rod S. Berman, Los Angeles, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/622,944

(22) Filed: Jan. 12, 2007

(51) Int. Cl. B60N 3/10

(52) U.S. Cl. 248/312

(57) ABSTRACT

Provided herein is an item holder assembly that includes an attachment mechanism for attaching the assembly to an object such as a laptop computer, an item holder such as a beverage holder, and a flexible extension member connecting the attachment mechanism to the item holder.

### FIELD OF THE INVENTION

The present invention relates to attachable holders for items, and illustratively to an apparatus for holding a beverage container (such as a wine glass or soda can) or other items while a person works on a laptop.

### SUMMARY OF THE PREFERRED EMBODIMENTS

In accordance with a first aspect of the present invention there is provided an attachable holder assembly that includes an attachment mechanism for attaching the assembly to an object, an item holder, and an extension member connecting the attachment mechanism to the holder. In a preferred embodiment the items holder is a beverage container holder, the extension member is flexible and the attachment mechanism comprises a clip. In another preferred embodiment, the assembly is provided in combination with a laptop computer.

### BRIEF DESCRIPTION OF THE DRAWINGS

FIG. 1 is a side elevational view of a beverage container holder assembly in accordance with a preferred embodiment of the present invention; and

FIG. 2 is a top plan view of the beverage container holder assembly of FIG. 1.

Like numerals refer to like parts throughout the several views of the drawings.

### DESCRIPTION OF THE PREFERRED EMBODIMENTS

As shown in the drawings, for purposes of illustration, a preferred embodiment of the invention is a beverage container holder assembly 10.

For exemplary purposes only, described hereinbelow is a preferred embodiment wherein the beverage container holder assembly is used with a laptop computer 100. For example, this embodiment would be useful for someone who likes to drink a glass of wine while operating the computer but does not have a convenient place to rest the glass of wine when operating the computer. However, this is not a limitation on the present invention. It will be understood that the beverage container holder assembly can be used on other items.

It will be appreciated that terms such as “front,” “back,” “top,” “bottom,” “side,” and “below” used herein are merely for ease of description and refer to the orientation of the components as shown in the figures. It should be understood that any orientation of the beverage container holder assembly, and the components thereof described herein is within the scope of the present invention.

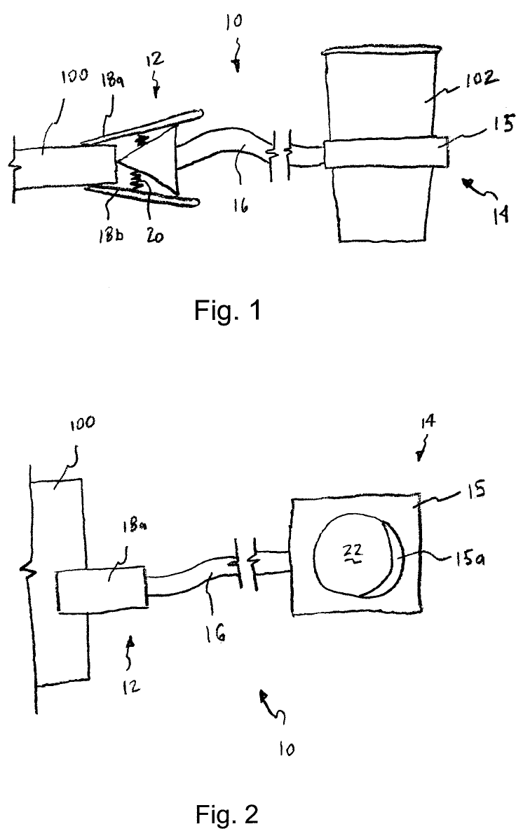

Referring to FIGS. 1-2, the invention is preferably embodied in a beverage container holder assembly 10. The type of beverage container 102 is not a limitation on the present invention. For example, the container 102 can be a cup, can, bottle, etc.

Beverage container holder assembly 10 generally includes an attachment mechanism 12, a beverage container holder 14 and an extension member 16 extending therebetween. In a preferred embodiment, the attachment member 12 is a clip. However, the attachment member 12 can also be a clamp or use other attachment means, such as screws, nuts, bolts, magnetics, etc. Any item that attaches the remaining components of the beverage container holder assembly 10 to a laptop or the like is within the scope of the present invention, provided it is adequate to maintain the attachment while supporting the weight of the holder and the item in the holder.

In an exemplary embodiment where the attachment mechanism 12 is a clip, the clip includes two opposing portions 18a and 18b that clamp onto the laptop 100. These two opposing portions 18a and 18b are normally biased in a closed position by a spring 20 or the like. When the distal ends of the clip are moved inwardly, the opposite ends spread apart, thereby allowing the clip to be affixed to the laptop 100.

It will be appreciated by those skilled in the art that the beverage container holder 14 can be any item for holding a beverage container. Many such items are known in the art. Generally, the beverage container holder includes an outer portion 15 that has a container receiving opening 22 defined therethrough. The outer portion 15 does not have to completely surround the opening 24, as long as a beverage container 102 can be supported therein.

In a preferred embodiment, the beverage container holder 14 includes an adjustable portion 15a that allows different sized containers 102 to be secured therein. This adjustable portion 15a can be spring biased. Example of such holders include those that are used for supporting beverages in automobiles such as BMW automobiles.

It will be appreciated by those skilled in the art that the extension member 16 is any component that extends between the attachment mechanism 12 and the beverage container holder 14, thereby allowing the beverage container holder 14 (and the container 102 therein) to extend away from the laptop 102. In a preferred embodiment, the extension member 16 is a flexible tube or the like that allows the extension member 16 to be adjustable, thereby allowing the beverage container holder 14 to be positioned in a plurality of positions. The flexibility of the extension member can be achieved by a variety of structures known in the art and can be of desired lengths and thicknesses. Preferably, the assembly can be collapsed into a small structure for easy storage and transport and packaging, and it can also be held in a pouch. Preferably the length of the extension member can range from about 2 inches to 24 inches, more preferably 3 inches to 12 inches and even more preferably from 3 inches to 6 inches.

It will also be appreciated that in addition to a beverage container holder, the holder can include a container for holding items, such as, for example, pens, pencils, notepads, snack foods; other electronic devices such as ipods, radios, recorders, cameras, or it can be a tray for supporting any items of use to the user of the thing to which it is attached, such as a laptop. The holder can also be attached to the assembly in a manner whereby various different types of holders can be interchanged. Further, a customer could be provided with a kit containing the assembly with various holders.

The assembly can also be labeled with a variety of graphics including those of the laptop source or of the item source, so as to function for advertising. For example, the Coca-Cola Company could label the holders with the Coke® mark and thereby be used as a promotion.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. An assembly comprising:
a) an attachment mechanism;
b) a holder for items; and
c) a flexible extension member connecting the attachment mechanism to the holder.

2. The assembly of claim 1 wherein the attachment mechanism comprises a clip.

3. The assembly of claim 2 wherein the clip is spring biased.

4. The assembly of claim 1 wherein the extension member comprises a flexible tube that is attached to the attachment mechanism at one end and a beverage container holder at the opposite end.

5. The assembly of claim 4 wherein the beverage container holder includes an adjustable portion, whereby different sized beverage containers can be received therein.

6. The assembly of claim 1 in combination with a laptop computer.

7. A laptop computer assembly consisting essentially of:
a. a laptop computer; and
b. an item holder, wherein the item holder includes means for connecting the item holder to the laptop computer; means for holding an item; and flexible means for connecting the holding means to the item holder such that the item is accessible to the user of the laptop computer.

8. A method for using a laptop computer while making readily accessible to the user items of use to the user, the method comprising:
a. providing the user with the assembly of claim 1; and
b. instructing the user to attached the assembly to the laptop.

9. The assembly of claim 1 whereby the assembly is provided in kit form with at least two different type holders.

10. The assembly of claim 1 wherein at least a portion of the assembly includes source indicia of the items to be held by the holder.
